(19) United States
(12) Patent Application Publication
(10) Pub. No.: US 2011/0162243 A1
(43) Pub. Date: Jul. 7, 2011

(54) SYSTEM AND A METHOD FOR SIGNALING

(76) Inventor: RAMI KALLIR, Givat Ada (IL)

(21) Appl. No.: 12/940,045

(22) Filed: Nov. 5, 2010

Related U.S. Application Data
(60) Provisional application No. 61/258,239, filed on Nov. 5, 2009.

(51) Int. Cl. G09F 19/12; G09F 13/16; G09F 7/00

(52) U.S. Cl. 40/427

(57) ABSTRACT

A road sign that is intended to create a perception of movement and/or modification in the road sign, when a distance of perceptor (usually a driver, but may also be implemented for other people) from the road signs is changing—for example, when a drivers drives towards the road sign. The road sign utilizes various optical means, techniques and effects to create a perception of motion, movement, or modification in the road signs, when perceived by an external viewer.

### RELATED APPLICATION

This application claims priority from US patent filing date Nov. 5, 2010, Ser. No. 61/258,239.

### BACKGROUND OF THE INVENTION

Directing attention of people towards different items is desirable in many fields such as safety management, products design, advertising, user interfaces, and so forth. For example, in the field of road safety management, it is known in the art that a great deal of severe traffic accident results from drivers not obeying to road signs, e.g. “Stop!” signs, and “Give Way” signs. Many a time the drivers claim to not have seen the road sign, or not noticing it enough time ahead of the action required.

The human visual perception is similar to that of predators, having both eyes at the front of the head. Like different predators, the human brain tends to disregard inanimated objects, and give high priority to objects in motion—which are perceived as such which may either be a threat, a competition, or a pray.

The human perception therefor tends to ignore inanimated road signs. A common prior art solution is the use of blinking lights, as in work on the road signalling, or a blinking signalling lights of cars.

However, such solution are relatively expansive, and require a power source, which may need replacement or recharment at different times, and thus is not proctical for a nation-wide road signs system.

### BRIEF DESCRIPTION OF THE INVENTION

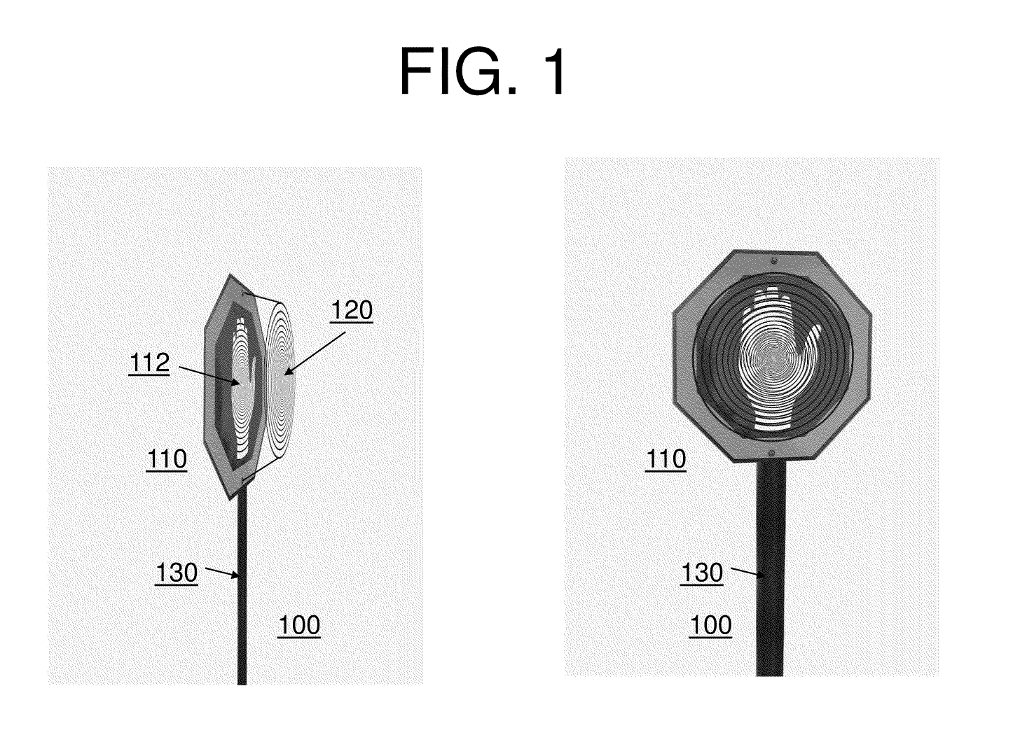

FIG. 1 illustrates a road sign of a first road sign type, according to an embodiment of the invention;

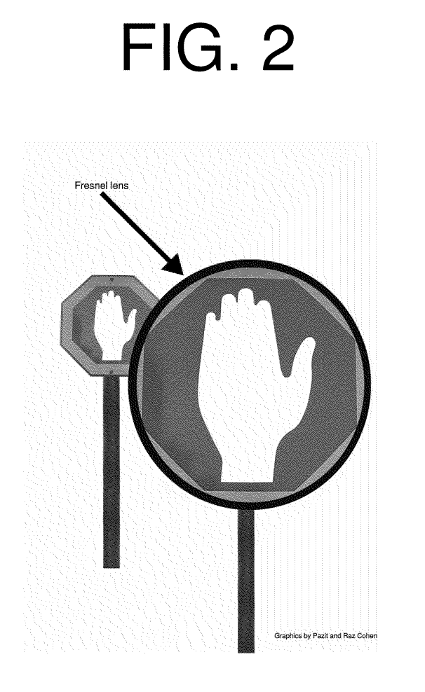

FIG. 2 illustrates a road sign according to another embodiment of the invention;

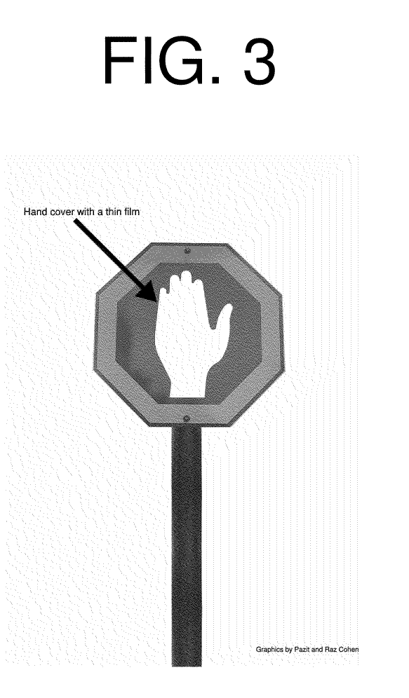

FIG. 3 illustrate a road sign of the second type, according to an embodiment of the invention;

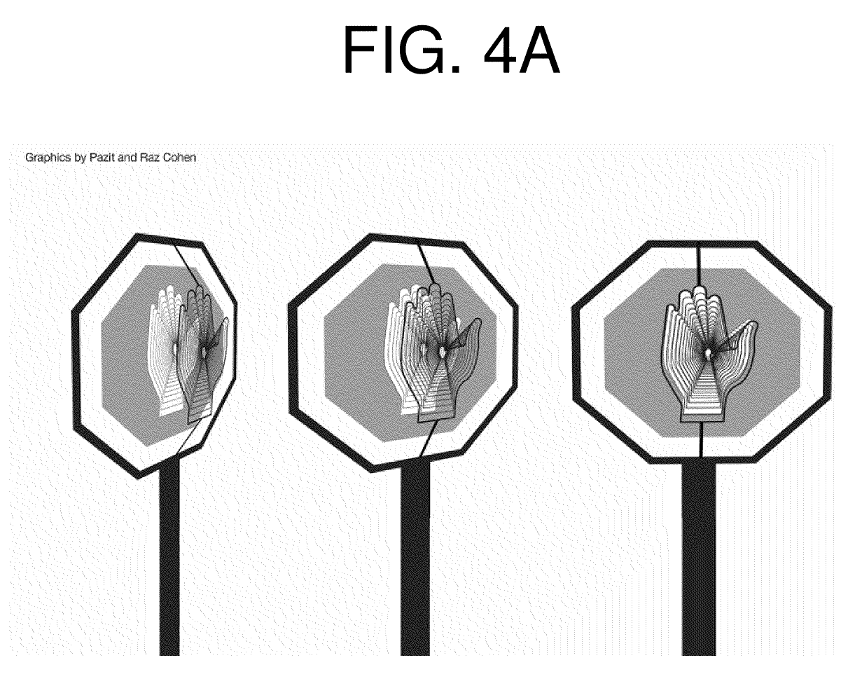

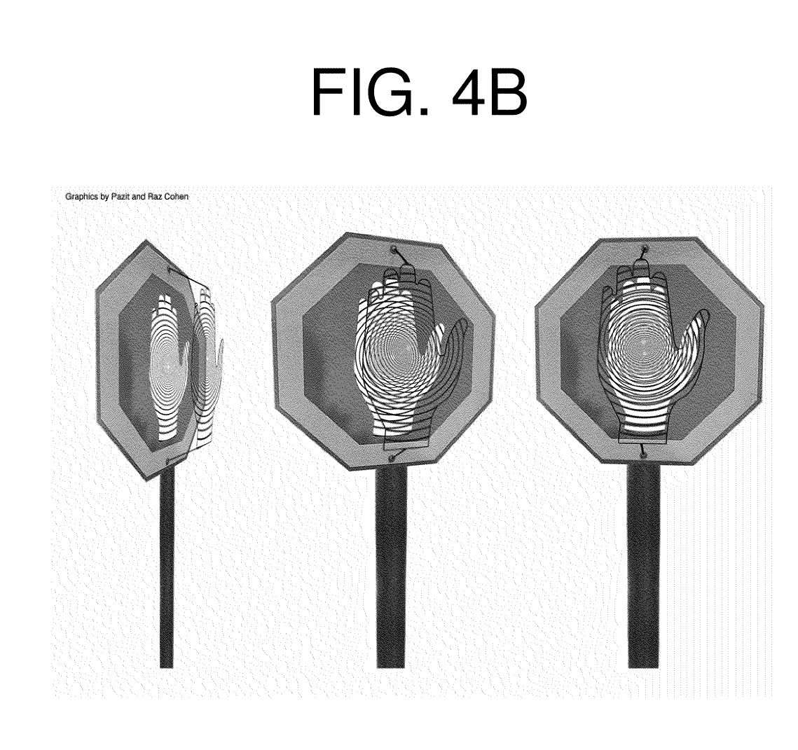

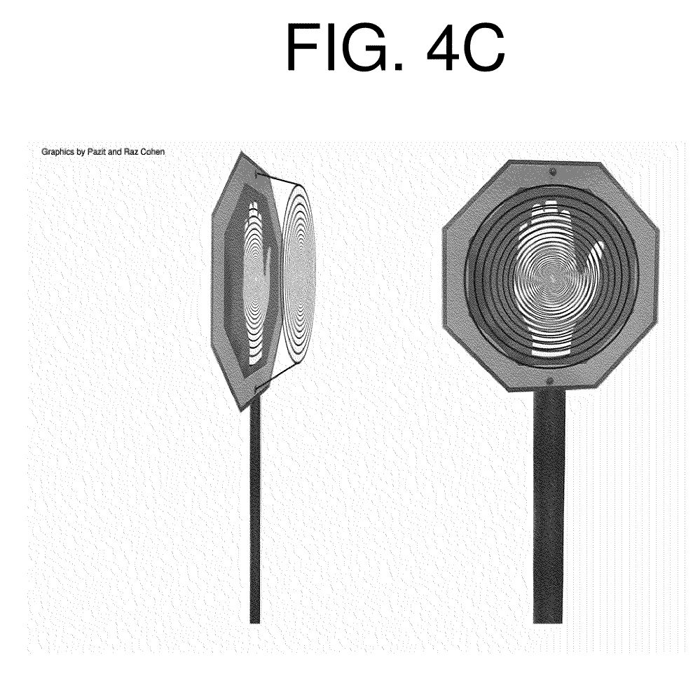

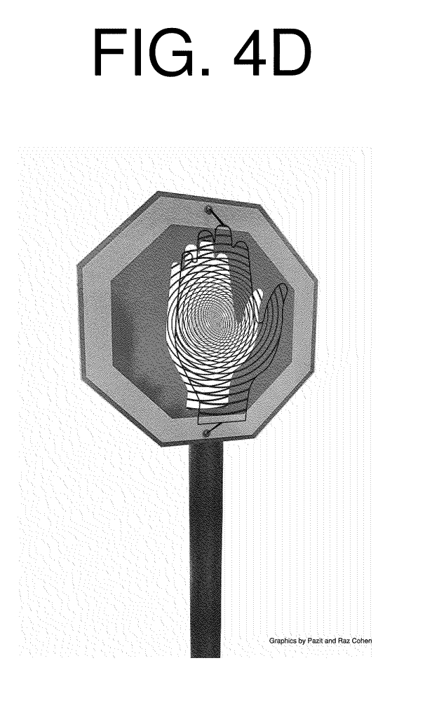

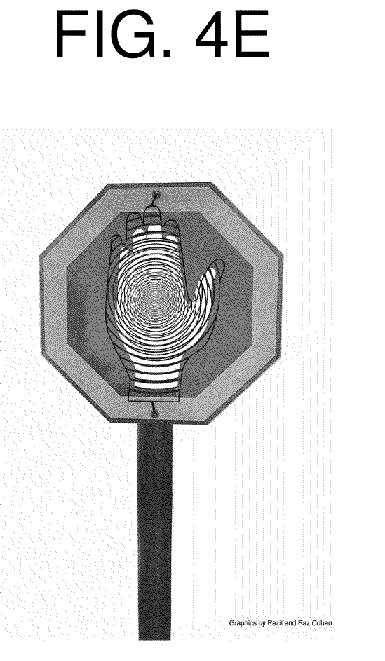

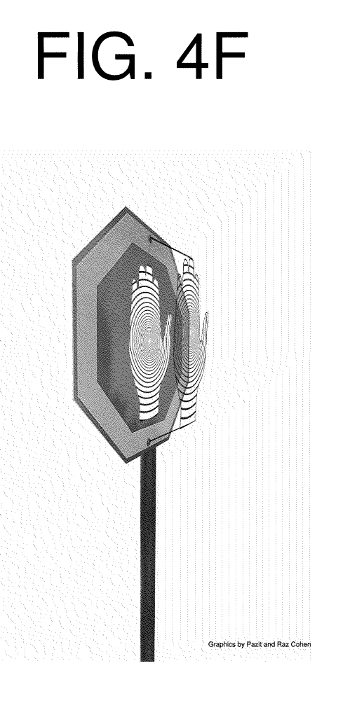

FIGS. 4A, 4B, 4C, 4D, 4E, and 4F illustrate different road signs that implement moiré paterns, and exemplifies different appearances of which—e.g. from different angles;

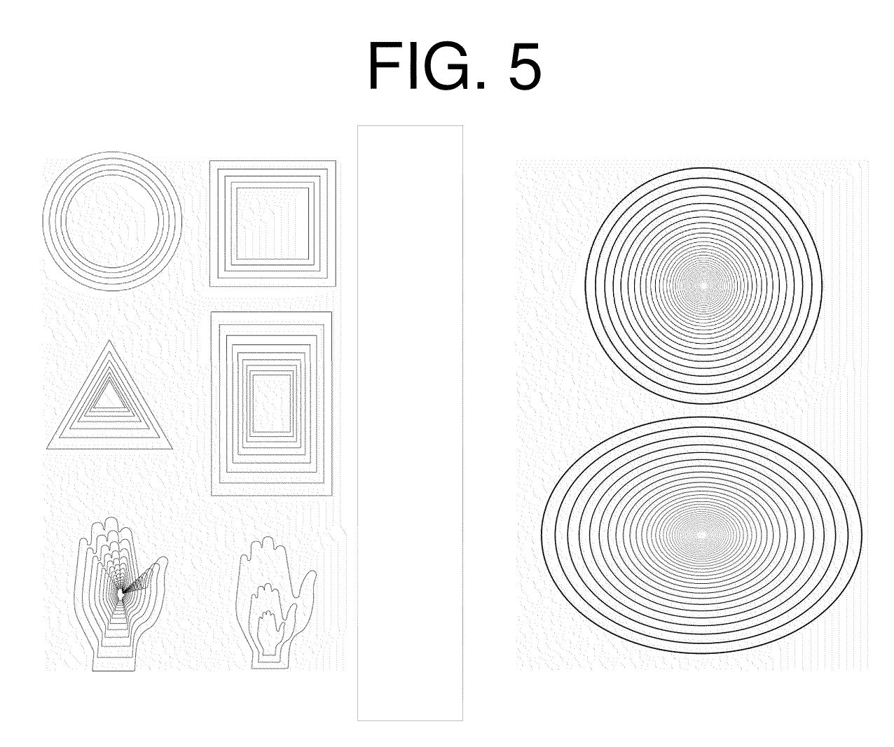

FIG. 5 illustrates various patterns which may be used for implementing of the third type of optical modifier, according to various embodiments of the invention;

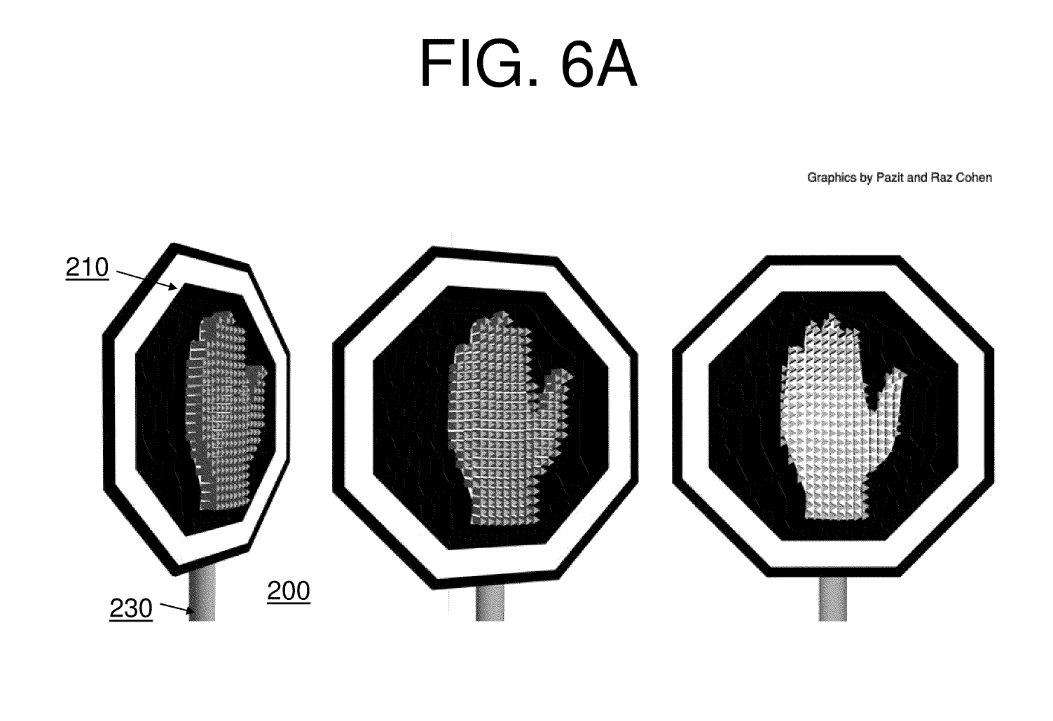

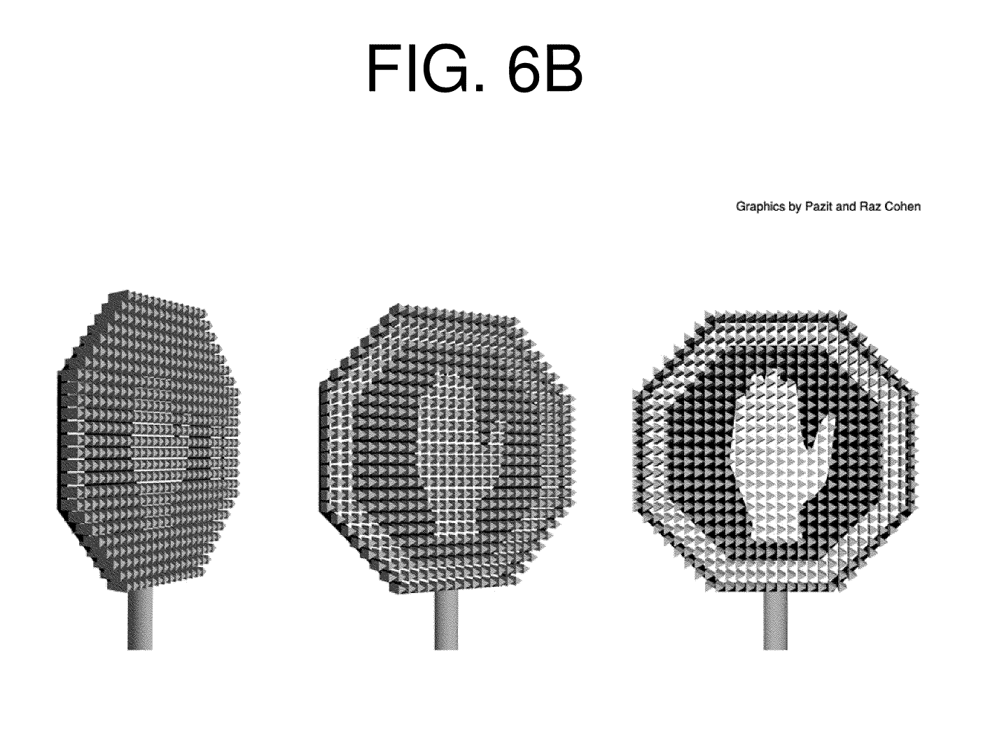

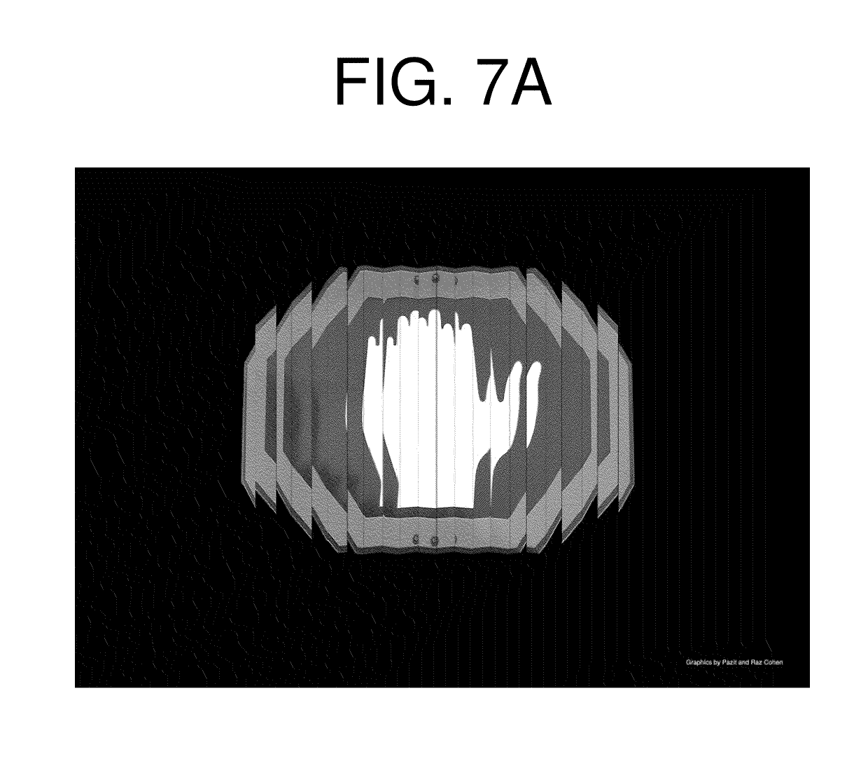

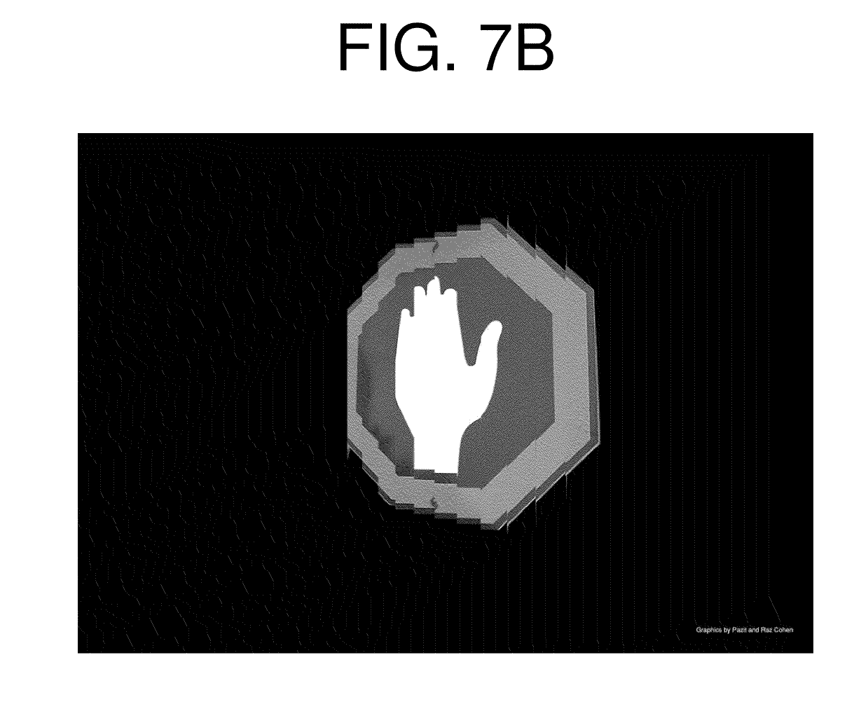

FIGS. 6A, 6B, 7A, and 7B illustrate a second type of a road sign, according to various embodiments of the invention;

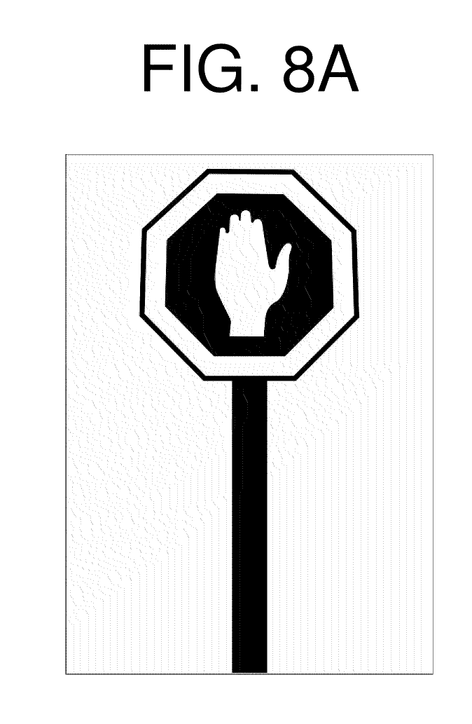

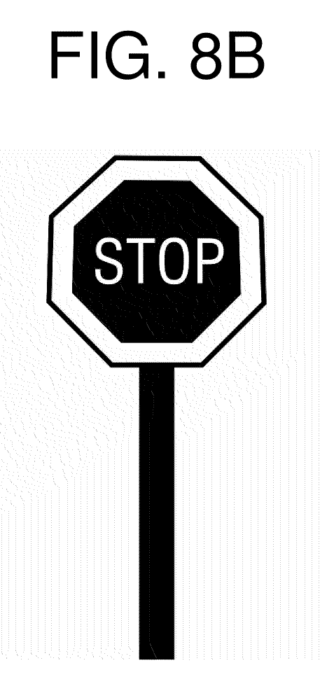

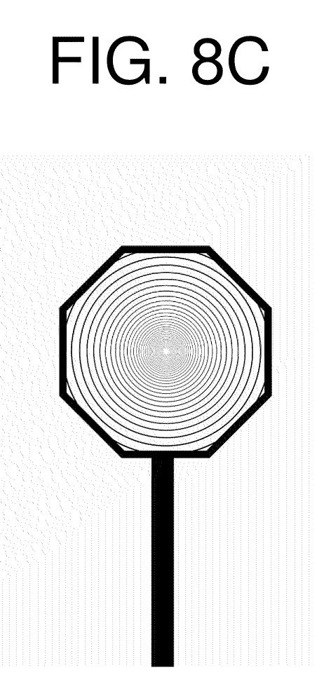

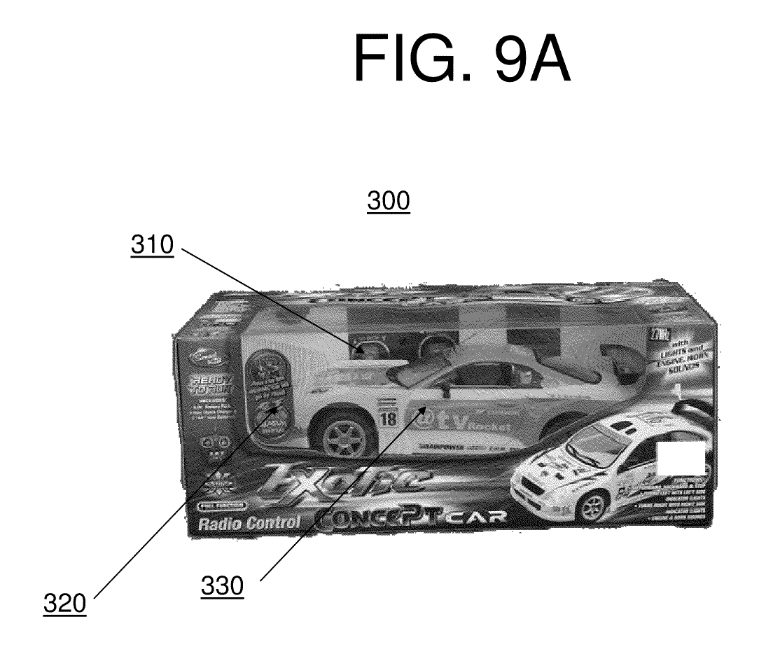

FIGS. 8A, 8B, and 8C illustrated different parts of road signs, according to two embodiments of the invention;

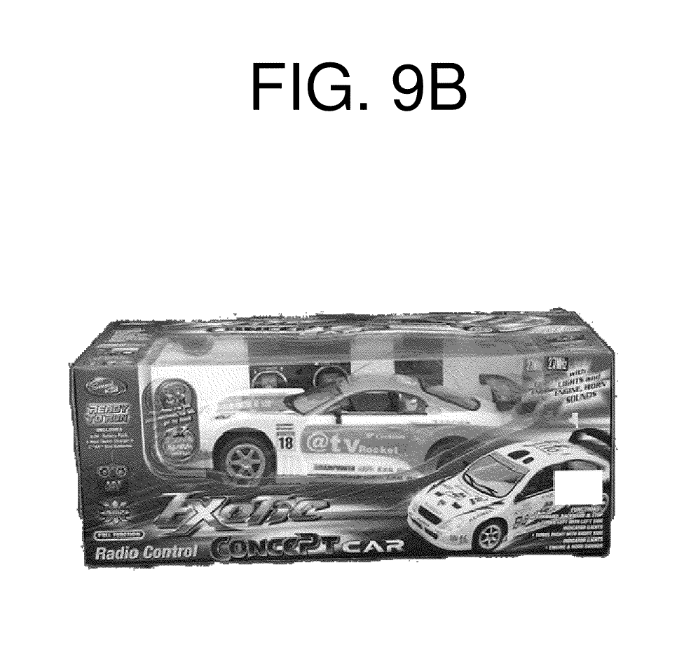

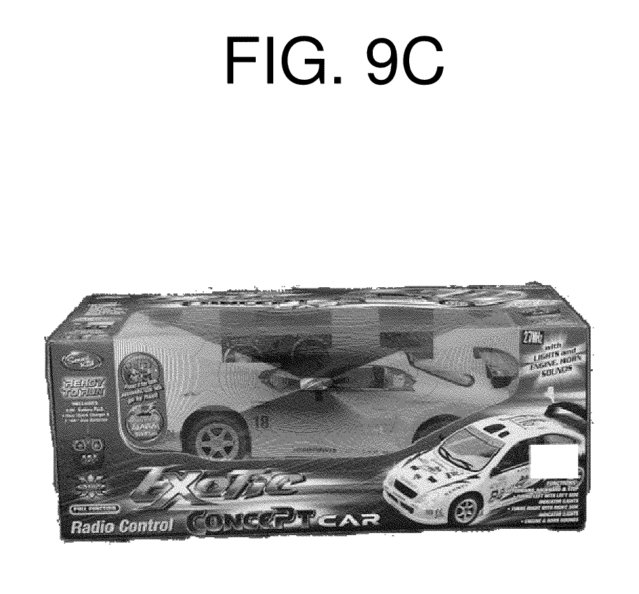

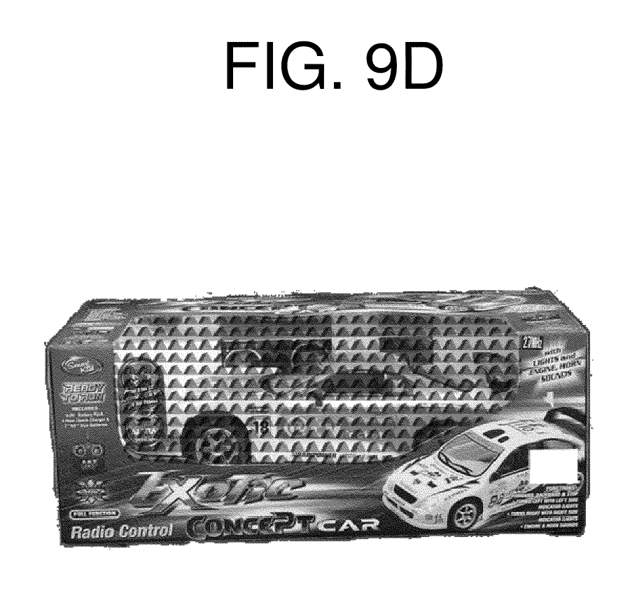

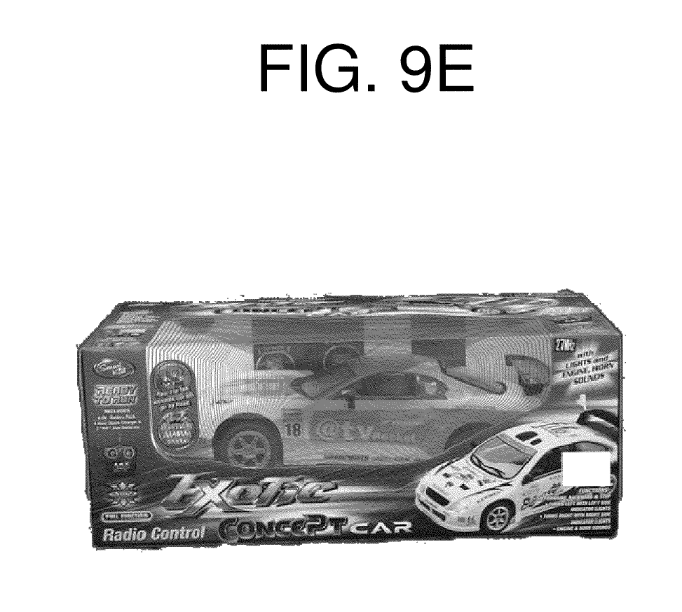

FIGS. 9A, 9B, 9C, 9D, and 9E illustrate an embodiment of the invention in which the techniques used above for road signs are implemented for packaging of items; and

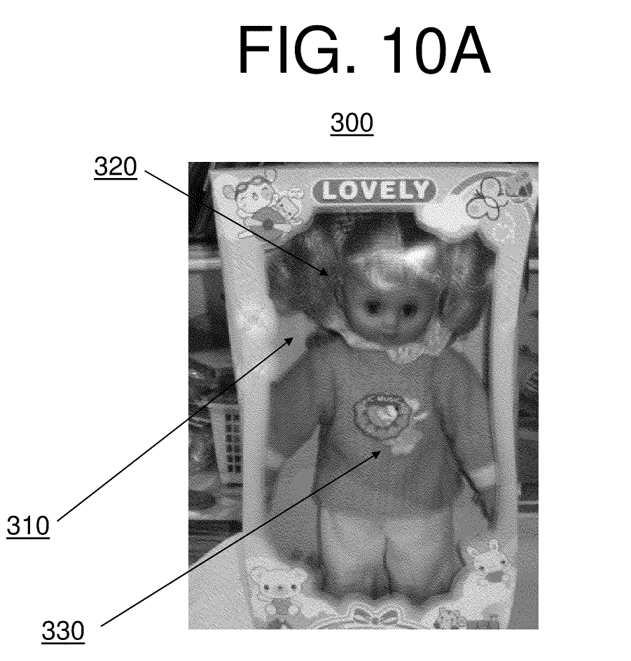

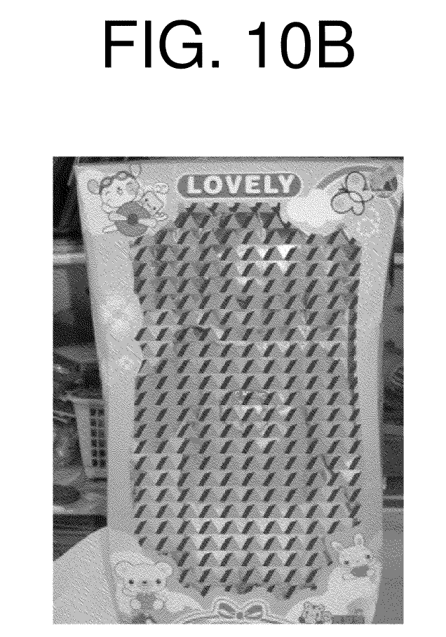

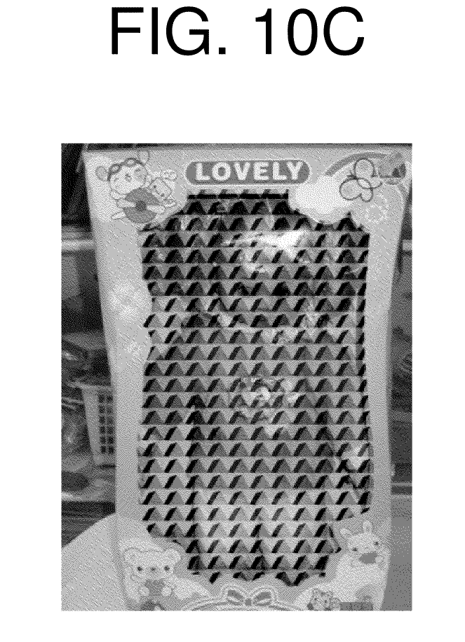

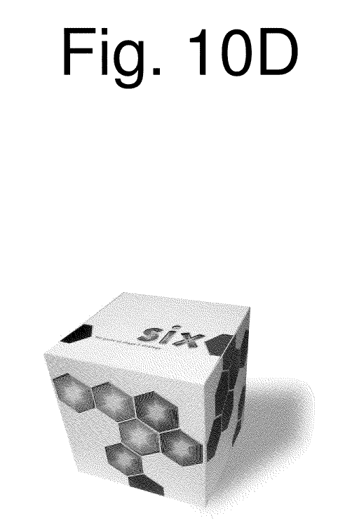

FIGS. 10A, 10B, 10C and 10D show other box/packaging, according to another embodiment of the invention.

### DETAILED DESCRIPTION OF THE INVENTION

The subject matter regarded as the invention is particularly pointed out and distinctly claimed in the concluding portion of the specification. The invention, however, both as to organization and method of operation, together with objects, features, and advantages thereof, may best be understood by reference to the following detailed description when read with the accompanying drawings.

It will be appreciated that for simplicity and clarity of illustration, elements shown in the figures have not necessarily been drawn to scale. For example, the dimensions of some of the elements may be exaggerated relative to other elements for clarity. Further, where considered appropriate, reference numerals may be repeated among the figures to indicate corresponding or analogous elements.

In the following detailed description, numerous specific details are set forth in order to provide a thorough understanding of the invention. However, it will be understood by those skilled in the art that the present invention may be practiced without these specific details. In other instances, well-known methods, procedures, and components have not been described in detail so as not to obscure the present invention.

In the following detailed description of the invention, reference is made to the accompanying drawings that form a part hereof, and in which is shown, by way of illustration, specific embodiments in which the invention may be practiced. These embodiments are described in sufficient detail to enable those skilled in the art to practice the invention. Other embodiments may be utilized and structural or other changes may be made without departing from the scope of the present invention.

It is noted that the systems, methods, and technique herein disclosed may be implemented in different ways and in different fields of the art. Therefore, it should be noted that features which may be implemented in various embodiments of the invention and which are disclosed in relation to some implementations—e.g. road signs—may also be implemented for other utilization—e.g. packaging.

A road sign that is disclosed herein is intended to create a perception of movement and/or modification in the road sign, when a distance of perceptor (usually a driver, but may also be implemented for other people) from the road signs is changing—for example, when a drivers drives towards the road sign. It is noted that the invention may also relate to signs which are not road signs (e.g. warning signs in industrials areas or near heavy machinery, commercial signs next to roads, and so forth), and to signs which are not stationary (e.g. a sign or other message carrying surface which may be placed on a moving vehicle—e.g. “Children in the car” sign on the back of a car). It is noted that whenever the term “road sign” is used, other types of signs may also be implemented, according to various embodiments of the invention.

The different roads signs disclosed herein utilize various optical means, techniques and effects to create a perception of motion, movement, or modification in the road signs, when perceived by an external viewer. Some of the road signs disclosed create the motion perception only when a position of the perceptor (from herein forward referred to as “the driver” for simplicity) is changing in relation to the road signs, while a motion perceptions in other disclosed road signs may also be created when the driver is substantially not moving in relation to the road sign.

FIG. 1 illustrates a road sign 100 of a first road sign type, according to an embodiment of the invention. The first road sign includes a symbol surface 110 which is a surface, usually made from durable and usually rigid material—on which a symbol 112 or a textual message is displayed, which conveys the message to be perceived by the driver. For example, in a “Stop!” sign, a human hand is used as the symbol, which signifies to the driver that he is required to stop his vehicle. It is noted that the symbol surface may be made from plastic, from metal, and may have different optical features (e.g. opaque or partly transparent, light refracting or not, and so forth). It is noted that the symbol surface may be positioned substantially perpendicularly to an expected direction of motion of the driver (e.g. perpendicular to a road), but this is not necessarily so.

The symbol surface may usually includes connecting means or preparation for which, in order to connect the sign to another object—e.g. a post 130, a wall, or a vehicle. It is noted that in other embodiments of the invention (usually not for road signs), the symbol surface may be transparent or at least partially transparent, so that an object and/or a symbol and/or other visually significant information may be perceived (e.g. the symbol surface may be a semi-transparent side of a box, the interior of which—e.g. a doll—is visible).

The first road sign further includes an optical modification structure, surface, or object, referred to generally as “optical modifier” below, and generally denoted 120. The optical modifier modifies a view of the symbol surface when moving in respect to the symbol surface, or when the driver moves in relation to the first road signs. Examples to different optical modifiers are given below.

It is noted that the symbol surface may be an already existing symbol surface of a prior-art road sign, in which case the invention may include of the optical modifier, and of connecting means to connect the optical modifier the prior art symbol surface. Generally, it is noted that either similar or different optical modifiers may be used for different types of symbol surfaces, according to different embodiments of the invention.

It is also noted that different optical modifiers may be used to optically modify different parts of the symbol surface, in different embodiments of the invention—e.g. the entire symbol surface, substantially the symbol area, substantially “empty areas” (not including the one or more symbols), a frame area of the symbol surface, and so forth.

A first optical modifier of the first road sign is an optical lens (e.g. as illustrated in FIG. 2), e.g. a flat lens, such as a fersnel lens. The optical lens may be a magnifying lens, but may have other optical features (e.g. distortional features). It is noted that as the distance between the symbol surface and driver is changing, the visual image perceived by the driver is different—for example the symbol surface (or at least a portion of which) may appear larger/smaller, in or out of focus, or distorted in different ways (usually in small enough distortions, which enables recognition of the symbol), as the driver changes position inrelation to the road sign.

The lens may be made from a durable material such as plastic. The lens may be of substantially the same size of the symbol surface (or of the symbol itself). The lens may be located in a fixed distance from the symbol surface (e.g. few centimeters), and may be installed so it can move in relation to it. The lens may be substantially parallel to the symbol surface, or at an angle to which. According to an embodiment of the invention, the lens may be installed on a hinge, so when it rotates in relation to the symbol surface, the symbol is viewed in different ways.

According to an embodiment of the invention, different patterns may be printed or otherwise presented on the lens, e.g. as discussed below.

A second type of optical modifier is an at least partially reflective film or layer or coating (generally referred to as film), which may be adjacent to at least a portion of the symbol surface, e.g. as illustrated in FIG. 3. Such reflective film may have dispersive features (or such features may be a part of the texture of the symbol surface), so that dispersion effects may take place—resulting in reflection of different colors in different viewing angles. Such an effect may resemble the effect of rainbow reflections known from compact discs. The reflecting film may include a coating of aluminum, but this is not necessarily so. The reflecting film may be a very thin layer of substantially transparent plastic materials. The thin layer of the reflecting film may cause light interferences which results in different colors appearing in different angels and distances from the road signs.

FIG. 3 illustrate a road sign of the second type, according to an embodiment of the invention.

A third type of optical modifier includes at least one geometrical patern, wherein at least a portion of the symbol surface (usually areas that do not include the symbol itself, only the symbol, the symbol and the frame area, and so forth) also include a geometrical patern. Alternatively, more than a single patterned surface may used as an optical modifier. The geometrical paterns on the two (or more) surfaces results in different optical effects which may be non-linear in perception. That is, a small movement of the driver in relation to the road sign (or of different patterned surfaces) may result in significant appearance of motion.

For example, the paterns known as moire patents may be used. FIGS. 4A, 4B, 4C, 4D, 4E, and 4F illustrate different road signs that implement moiré paterns, and exemplifies different appearances of which—e.g. from different angles. It is noted that the geometrical paterns may be printed on a substantially transparent surface (or surfaces), may be featured on a cut surface (e.g. a cutted-out rigid plastic surface of a selected color), may be presented as a projecting structure, and so forth.

It is noted that the one or more surfaces/object carrying geometric patterns may be allows some motion in relation to the symbol surface (or to each other), so that small movement—e.g. resulting from wind or from air motion resulted by cars—may cause the small movement of the geometric paterns in relation to each other—which result in appearance of movement.

It is noted that the optical modifier may include of a curved surface—e.g. a half sphere—having a geometric patern printed/cutted into it, so it may be visible from wider angles in relation to a flat surface.

It is noted that other optical modifiers may be used as well. It is noted that more than one type of optical modifier may be used in a single sign. It is noted that the optical modifiers may be used with the other types of road signs discussed below.

FIG. 5 illustrates various patterns which may be used for implementing of the third type of optical modifier, according to various embodiments of the invention.

As aforementioned, all the variations of the first type of road sign may be extended to other types of products—such as boxes, cars, user interfaces, and so forth.

FIGS. 6s A, 6B, 7A, and 7B illustrate a second type of road sign 200, according to various embodiments of the invention. In the second type of road sign 200, the symbol surface itself 210 is shaped to have different types of optical features. Connecting means (not shown) are connected to the symbol surface (e.g. bolts, holes for bolts, glue, etc.) for connecting the symbol surface to another object (e.g. post 230).

The road sign may include of a shaped, curved, dented, or otherwise non-flat surface, which results in the symbol surface appearing different from different angles and/or distances. For example, non-flat symbol surface may result of different light reflections from the symbol surface (e.g. resulting from sunlight), which change as the driver drives toward the road sign. The symbol itself may also appear different from different angels/distances. It is noted that generally, the symbols may be designed to enhance the different optical effects of the different types of road signs.

According to an embodiment of the invention, the symbol surface is constructed from a series of angled-positioned portions, wherein each adjacent surface portions are positioned in an angle in relation to each other. For example, every “odd” surface portion may have a first angle in relation to a reference plane (e.g. a wall on which the sign is placed), while every “even” surface portion may have a second angle in relation to the reference plane (which may be an opposing angle, but not necessarily so). Conveniently, at least to symbols are present on the symbol surface—one or more first symbols on the “odd” portions, and one or more second symbols on the “even” portions. It is noted that the first and the second symbols may be similar (e.g. stop! Symbols) or different, or have small differences (e.g. slightly different size). From different angles and/or distances, different potions of each of the first and second symbols are viewed by the driver. It is noted that the symbol surface may be manufactured from a singled surface which is bent into the form disclosed.

FIG. 7A illustrate a first view of a symbol surface as discussed above, and FIG. 7B illustrate the same symbol surface from a different angle, so that substantially only the first symbol is visible.

In another embodiment of the invention—e.g. as illustrated in FIGS. 6A and/or 6B, the symbol surface (which may be light reflective) includes three dimensionally curved surface, with multiple projected structures (e.g. in a shape of prisms), wherein two or more similar symbols having one or more different features—such as size, inclination and/or color—are presented on different sides of the projected structures (i.e. each of the different similar symbols is printed or presented on the sides of many projected structures together), so that when the distance/angle of the driver in relation to the road sign changes, different ratios between the visibility of the different representations of the symbols on the different sides of the respective projected structured is created, resulting in different view of the symbol. For example, the symbol may appear to change color.

FIGS. 6A and 6B illustrate road signs having multiple projected prism shaped structures, according to different embodiments of the invention.

In a third type of road sign, either the symbol surface or another surface includes geometrical patern (e.g. as described above), while another moving geometrically patterned surface—which is usually substantially transparent, moves with the driver, so the respective movement between the moving geometrically patterned surface and between the stationary geometrically patterned surface of the road sign creates an illusion of motion—e.g. as discussed above. For example, the geometric patterns may create a Moire patern. For example, the moving geometrically patterned surface may be a wind shield of a vehicle in which the driver drives. It is noted that the geometrical patern on the wind shield may be relatively delicate, and relatively not interfering with visual displays that are not similar to the geometrical patern of the road sign. For example, the geometrical patern of the wind shield may be design so as not to interfere with paterns that are frequent in a driving environment (e.g. vertical lines of light posts, road surface markings and so forth).

A forth type of road sign includes a symbol surface—which may be concaved, but not necessarily so—where additional symbols resembling human features—e.g. face, eyes, pointing finger, etc.—are further presented on the road sign, for creating an illusion that the road sign is looking at the driver. Those human features may also be presented externally to the symbol surface—e.g. on a post carrying the symbol surface.

Generally, it is noted that different embodiments of the road signs may be designed for different driving speeds, to create a visual effect which is perceivable and effective in a desired range of expected speeds.

Different methods for signing are also disclosed, wherein the different methods may match to one or more types of road signs discussed above.

A first method includes the stage of selecting a symbol for a road sign (or other apparatus, e.g. as discussed in relation other embodiments of the invention), and generating a road sign which is of one of the first, second, third and/or forth type of road sign discussed above, wherein the generating of the road signs includes using a symbol surface on which the selected symbol is presented.

A second method includes the stage of selecting a road sign symbol for a desired location (or target), and placing a road sign (or other apparatus, e.g. as discussed in relation other embodiments of the invention) which is of one of the first, second, third and/or forth type of road sign discussed above having the selected symbol presented on the symbol surface of which at the desired location.

A third method includes providing one or more optical modifiers (which may be one or more of the optical modifier discussed above), and connecting the one or more optical modifiers to an existing road sign (or other apparatus, e.g. as discussed in relation other embodiments of the invention), e.g. for increasing the visibility of the road sign.

A fourth method includes looking at a road sign (or other apparatus, e.g. as discussed in relation other embodiments of the invention) which is of one of the first, second, third and/or forth type of road sign discussed above from a first location, and looking at the road sign from a second location.

A fifth method includes looking at a road sign (or other apparatus, e.g. as discussed in relation other embodiments of the invention) that includes a geometrical patern from a moving vehicle through a wind shield of the vehicle that presents a geometrical patern from a first location, and looking at the road sign through the wind shield from a second location.

FIGS. 8A, 8B, and 8C illustrated different parts of road signs, according to two embodiments of the invention, wherein in FIGS. 8A and 8B a symbol surface and a post are shown, and in FIG. 8C an optical modifier and a post are shown.

FIGS. 9A, 9B, 9C, 9D, and 9E illustrate an embodiment of the invention in which the techniques used above for road signs are implemented for packaging of items, so that the item itself (and/or its packaging) will show an attention attracting optical features.

The box/packaging 300 may include an at least partially transparent window 310, on which (or close to which) an optical modifier 320 is presented, so that the packaged item 330 is viewed substantially differently (not only do to linear geometrical optics considerations) from different angles and/or distances.

FIGS. 10A, 10B, 10C and 10D show other box/packaging, according to another embodiment of the invention.

While certain features of the invention have been illustrated and described herein, many modifications, substitutions, changes, and equivalents will now occur to those of ordinary skill in the art. It is, therefore, to be understood that the appended claims are intended to cover all such modifications and changes as fall within the true spirit of the invention.

We claim:

1. An apparatus as substantially disclosed in the specification.

2. An apparatus as substantially disclosed in the drawings.

3. A method as substantially disclosed in the specification.
